(19) United States
(12) Patent Application Publication
(10) Pub. No.: US 2002/0091792 A1
(43) Pub. Date: Jul. 11, 2002

(54) Method and apparatus for client sharing of cached content

(75) Inventors: James P. Janniello, Fairfield, CT (US); Christopher Ward, Glen Ridge, NJ (US)

Correspondence Address: Ryan, Mason & Lewis, LLP, Suite 205, 1300 Post Road, Fairfield, CT, 06430, US

(73) Assignee: International Business Machines Corporation, Armonk, NY (US)

(21) Appl. No.: 09/938,147

(22) Filed: Aug. 22, 2001

Related U.S. Application Data
(60) Provisional application No. 60/260,594, filed on Jan. 9, 2001.
(60) Provisional application No. 60/286,064, filed on Apr. 24, 2001.

(51) Int. Cl. G06F 15/16

(52) U.S. Cl. 709/217

(57) ABSTRACT

A method and apparatus are disclosed for distributing content to multiple users, including at least one broadcast-enabled user. A broadcast-enabled user receives content for storage in a client-side cache over a broadcast connection and shares the cached content with one or more other users (who may or may not be broadcast-enabled users). Users that are not broadcast-enabled users can access the broadcast information and broadcast-enabled users can potentially access a richer set of cached information by sharing the cached information with other broadcast-enabled users. A central cache directory identifies one or more broadcast-enabled users that can provide each cached content item, such as each Web page. A client initially determines if desired content is available in a local client cache (Step 1) or a local broadcast cache, if available (Step 2), before accessing the central cache directory to determine if the requested item is available in the cache of another user (Step 3), or requesting the content from an edge server (Step 4) or the web site (Step 5) on the lower bandwidth channel.

### CROSS REFERENCE TO RELATED APPLICATIONS

This application claims the benefit of U.S. Provisional Application No. 60/260,594, filed Jan. 9, 2001 and U.S. Provisional Application No. 60/286,064 filed Apr. 24, 2001. This application is related to U.S. patent application Ser. No. ______, filed Aug. 14, 2001, entitled “Method and Apparatus for Broadcast Delivery of Content to a Client-Side Cache Based on User Preferences,” assigned to the assignee of the present invention and incorporated by reference herein.

### FIELD OF THE INVENTION

The present invention relates generally to the distribution of information for storage in a cache and, more particularly, to a method and apparatus for sharing information stored in a client-side cache among multiple users.

### BACKGROUND OF THE INVENTION

The delivery of digital content over broadcast channels is well known. For example, U.S. Pat. No. 6,021,419, entitled “System for Filtering Broadcast Digital Information In Accordance With Channel Identifiers Stored In Preference List Which Can Be Dynamically Updated Via Command Through Network,” hereinafter, referred to as the “Clarke et al. Patent,” assigned to the assignee of the present invention and incorporated by reference herein, discloses a typical satelllite-based broadcast distribution system. The Clarke et al. Patent may also be applied in the context of a terrestrial broadcast system.

In order to more efficiently deliver content over a large network, such as the Internet, and to thereby improve content delivery times, caching techniques are often employed. For example, most client computers maintain a cache of recently accessed Web pages. In addition, many Internet Service Providers (ISPs) maintain one or more edge servers on the edge of their networks, such as Akamai servers commercially available from Akamai Technologies, Inc. In this manner, requested content can be presented to a user more efficiently if the requested content can be retrieved from the local cache or an edge cache. The requested content is only obtained from the actual server of the content if the requested content is not found in the local cache or an edge cache.

U.S. patent application Ser. No. ______, filed Aug. 14, 2001, entitled “Method and Apparatus for Broadcast Delivery of Content to a Client-Side Cache Based on User Preferences,” discloses a caching mechanism that allows content to be broadcast to multiple users for storage in a client-side broadcast cache. While the disclosed caching mechanism allows information to be efficiently distributed to many users in a broadcast environment, not all users have access to information distributed by means of a broadcast channel. A need therefore exists for a method and apparatus for sharing information stored in a client-side cache among multiple users.

### SUMMARY OF THE INVENTION

Generally, a method and apparatus are disclosed for distributing digital content to multiple users. At least one user is a broadcast-enabled user that receives content for storage in a client-side cache over a broadcast connection. According to one aspect of the present invention, the broadcast-enabled user shares the cached content with one or more other users (who may or may not be broadcast-enabled users) over a point-to-point channel, such as a local area network (LAN). Thus, broadcast-enabled users have both a broadcast connection and a point-to-point connection and are responsible for caching information received over the broadcast connection. The cached information is then made available to other users over the point-to-point connection. Thus, users that are not broadcast-enabled users can access the broadcast information. In addition, broadcast-enabled users can potentially access a richer set of cached information by sharing the cached information with other broadcast-enabled users.

A central cache directory identifies one or more broadcast-enabled users that can provide each cached content item, such as each Web page. Each client computer includes a local cache that records material that has been accessed by the user. Each broadcast-enabled client computer includes a broadcast cache that records material that is predicted to be of interest to the user, in accordance with the present invention. Each broadcast-enabled client computer is connected to the network environment by a relatively high bandwidth unidirectional broadcast channel, and a second point-to-point channel, such as a lower bandwidth channel to the World Wide Web.

A client initially determines if desired content is available in a local client cache (Step 1) or, optionally, a local broadcast cache (Step 2) (for broadcast-enabled clients) before accessing the central cache directory to determine if the requested item is available in the cache of another user (Step 3), or requesting the content from an edge server (Step 4) or the web site (Step 5) on the lower bandwidth channel.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment 100 in which the present invention can operate;

FIG. 2 illustrates the flow of information according to the present invention in further detail;

FIG. 3 is a schematic block diagram showing the architecture of an exemplary client computer of FIG. 1;

FIG. 4 illustrates a data structure for the delivery of category-enhanced web pages in accordance with the present invention;

FIG. 5 is a sample table from the central cache directory of FIG. 2;

FIG. 6 is a flow chart describing an exemplary implementation of the cache maintenance process of FIG. 3; and

FIG. 7 is a flow chart describing an exemplary implementation of the web request handling process of FIG. 3.

### DETAILED DESCRIPTION OF PREFERRED EMBODIMENTS

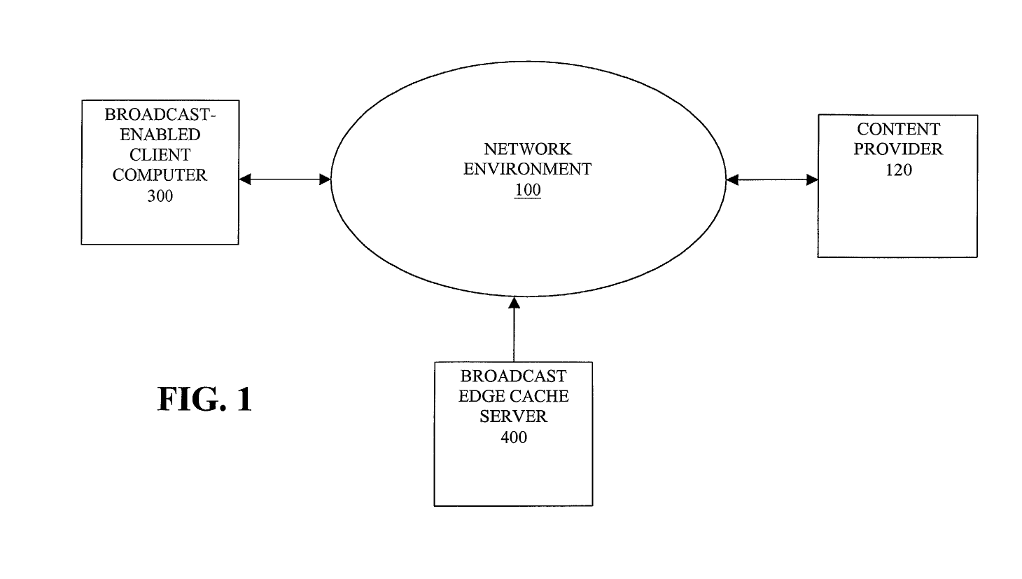

FIG. 1 illustrates a network environment 100 in which the present invention can operate. The present invention permits efficient web browsing that is improved by the broadcast delivery of content for client-side caching to at least one broadcast-enabled user. As used herein, a broadcast-enabled user is any user capable of receiving content for storage in a client-side cache over a broadcast connection. According to one aspect of the present invention, the broadcast-enabled user shares the cached content with one or more other users over a point-to-point channel, such as a lower bandwidth connection over a local area network (LAN). As discussed further below, the one or more other users may or may not be broadcast-enabled users.

Thus, broadcast-enabled users which have both a broadcast connection and a point-to-point connection are responsible for caching information received over the broadcast connection. This cached information is then made available to other users over the point-to-point connection, thereby enabling other users to access the cache information broadcast over a number of channels. In this manner, the present invention allows users that are not broadcast-enabled users to access the broadcast information, and allows broadcast-enabled users to potentially access a richer set of cached information by sharing the cached information with other broadcast-enabled users. For example, each broadcast-enabled user can monitor a predefined broadcast channel and share cached content with other broadcast-enabled users that are monitoring different broadcast channels.

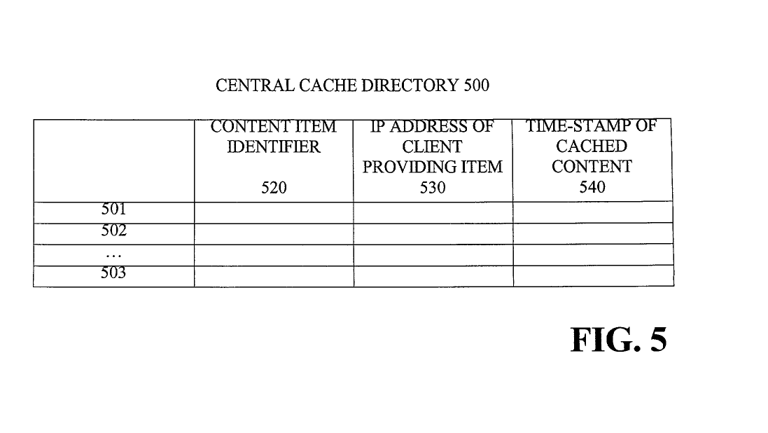

According to another aspect of the invention, a central cache directory 500, discussed further below in conjunction with FIG. 5, is maintained that identifies one or more broadcast-enabled users that can provide each cached content item, such as each Web page. Thus, as discussed further below, a client initially determines if desired content is available in a local client cache 270 (Step 1) or a local broadcast cache 275 (Step 2) before accessing the central cache directory 500 to determine if the requested item has been cached by another local user (Step 3), or requesting the content from the edge server 230 (Step 4) or the web site 220 (Step 5) on a lower bandwidth channel 215. The local cache 270 records material that the user has already accessed and the broadcast cache 275 records material that is predicted to be of interest to the user, in accordance with the present invention.

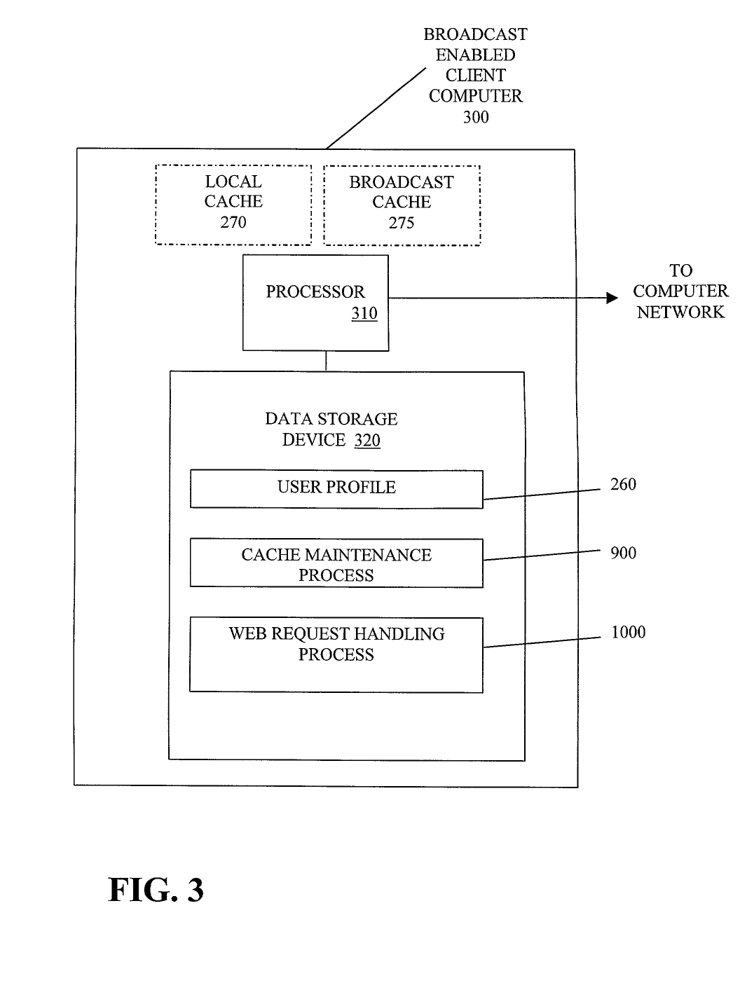

As shown in FIG. 1, one or more broadcast-enabled users employing a client computer 300-N, discussed below in conjunction with FIG. 3, access content provided by a content provider 120 over a network 100, discussed below. A broadcast edge cache server 250 delivers content over a broadcast channel (not shown in FIG. 1) to a large number of clients, including the exemplary broadcast-enabled client computer 300. The broadcast edge cache server 250 and the manner in which content is selected for distribution to the clients is beyond the scope of the present invention. Generally, the broadcast edge cache server 250 selects content from materials made available by traditional web servers 220, such as a web site, and web edge servers 230, such as an Akamai server, and other sources, based on a broadcast profile employed by a broadcast profiler 240. For a more detailed discussion, see U.S. patent application Ser. No. ______, filed Aug. 14, 2001, entitled “Method and Apparatus for Broadcast Delivery of Content to a Client-Side Cache Based on User Preferences,” assigned to the assignee of the present invention and incorporated by reference herein.

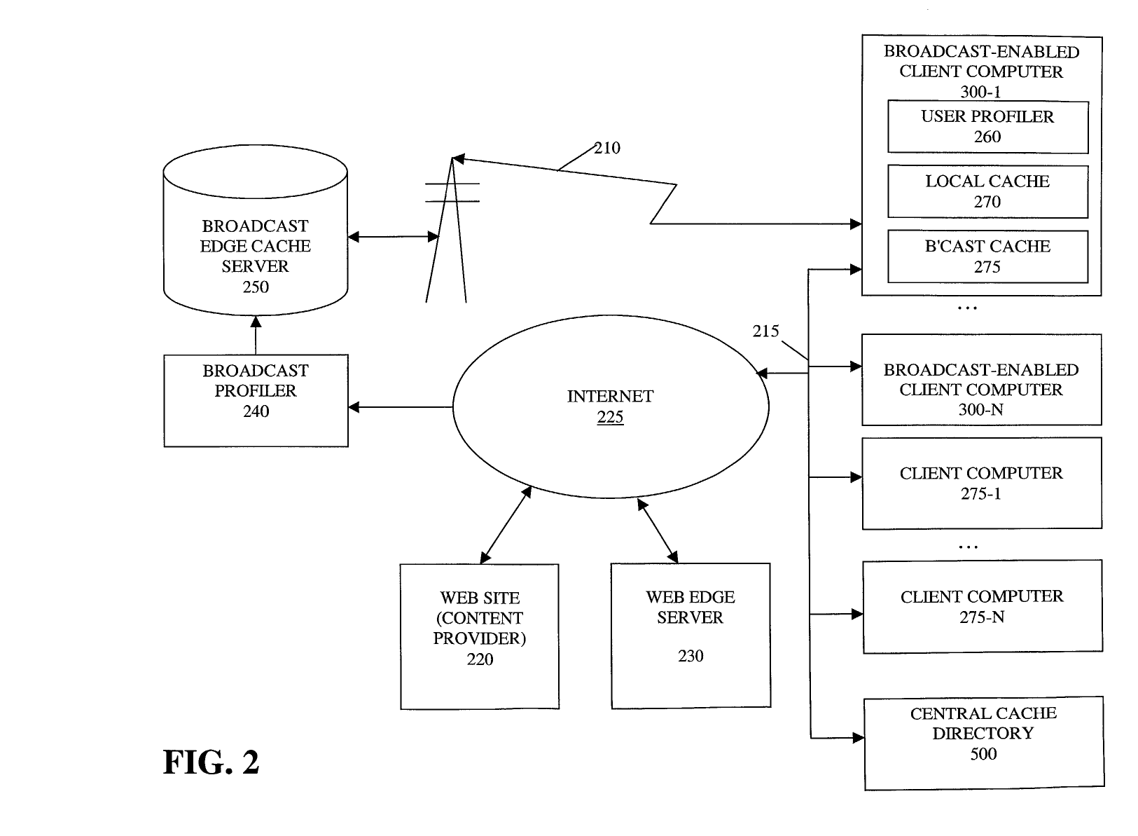

FIG. 2 illustrates the flow of information according to the present invention in further detail. According to one aspect of the present invention, the broadcast edge cache server 250 delivers content over a broadcast channel 210 to a large number of clients, including the exemplary broadcast-enabled client computer 300. The broadcast edge cache server 250 delivers the selected content predictively (i.e., in anticipation of its need by one or more clients) to clients as a supplement to other requested program material. Each broadcast-enabled client computer 300 stores a subset of this material based on a user profile 260. Non-broadcast-enabled clients 275 lack acess to a broadcast channel but rather access the material available on the broadcast-enabled client computers 300, as discussed herein.

A central cache directory 500, discussed further below in conjunction with FIG. 5, is a directory identifying one or more broadcast-enabled users that provide each cached content item, such as each Web page. The central cache directory 500 can be maintained using a “push” protocol where each broadcast-enabled client computer 300 must notify the central cache directory 500 of all updates to the cached content, or using a “pull” protocol, where the central cache directory 500 periodically polls each broadcast-enabled client computer 300 for a listing of the current cached content, or updates thereto. As indicated above, the broadcast edge cache server 250 may deliver the content over one or more broadcast channels, and each broadcast-enabled client computer 300 may monitor one or more of such broadcast channels for content of interest.

The network environment 100 of FIG. 1 may be embodied as any wired or wireless satellite or terrestrial network, or a combination thereof, such as the Internet, Multichannel Multipoint Distribution Service (MMDS) or Local Multipoint Distribution Service (LMDS) networks, Public Switched Telephone Network (PSTN), a digital satellite network or a 2.5G & 3G Wireless Networks, Wireless Access Protocol (WAP). Generally, each broadcast-enabled client 300 is connected to the network environment 100 by one or more relatively high bandwidth unidirectional broadcast channels, such as the channel 210, and a second point-to-point channel 215, such as a local area network (LAN) or a lower bandwidth dial-up PSTN channel to the Internet 225. The channel 210 may be embodied, for example, as one or more Digital Television (DTV) channels. The channel 215 may be embodied as a LAN or the local network of an Internet Service Provider (ISP) or a cable television service.

FIG. 3 is a schematic block diagram showing the architecture of an exemplary broadcast-enabled client computer 300. The broadcast-enabled client computer 300 may be embodied as a general purpose computing system, such as the general purpose computing system shown in FIG. 3. The broadcast-enabled client computer 300 includes a processor 310 and related memory, such as a data storage device 320, which may be distributed or local. The processor 310 may be embodied as a single processor, or a number of local or distributed processors operating in parallel. The data storage device 320 and/or a read only memory (ROM) are operable to store one or more instructions, which the processor 310 is operable to retrieve, interpret and execute. As previously indicated, each broadcast-enabled client computer 300 contains a local cache 270, a broadcast cache 275 and a user profile 260 in accordance with the present invention.

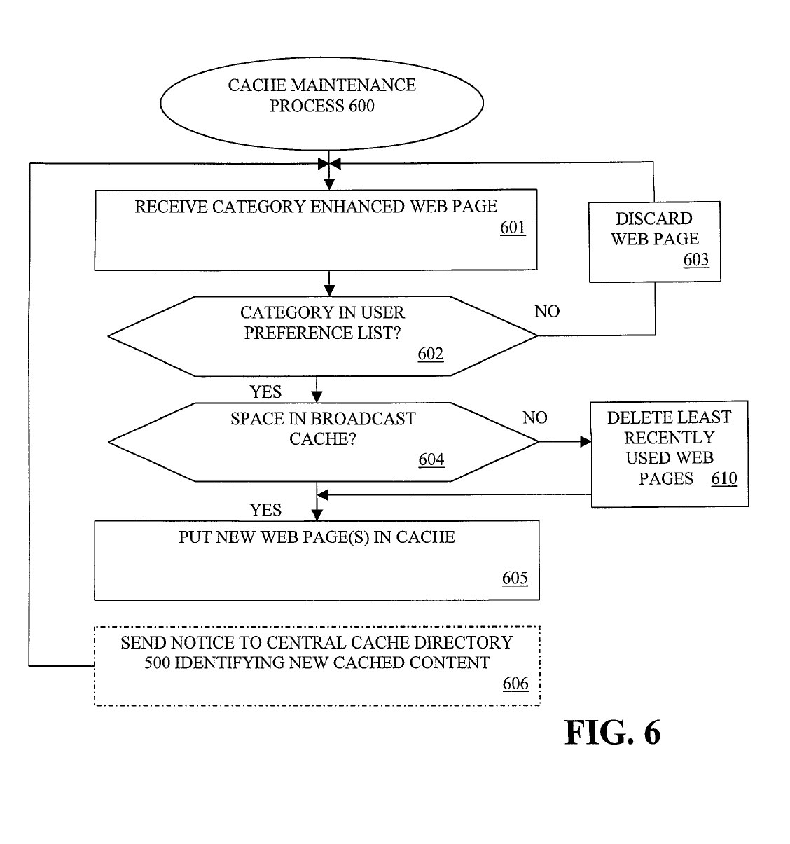

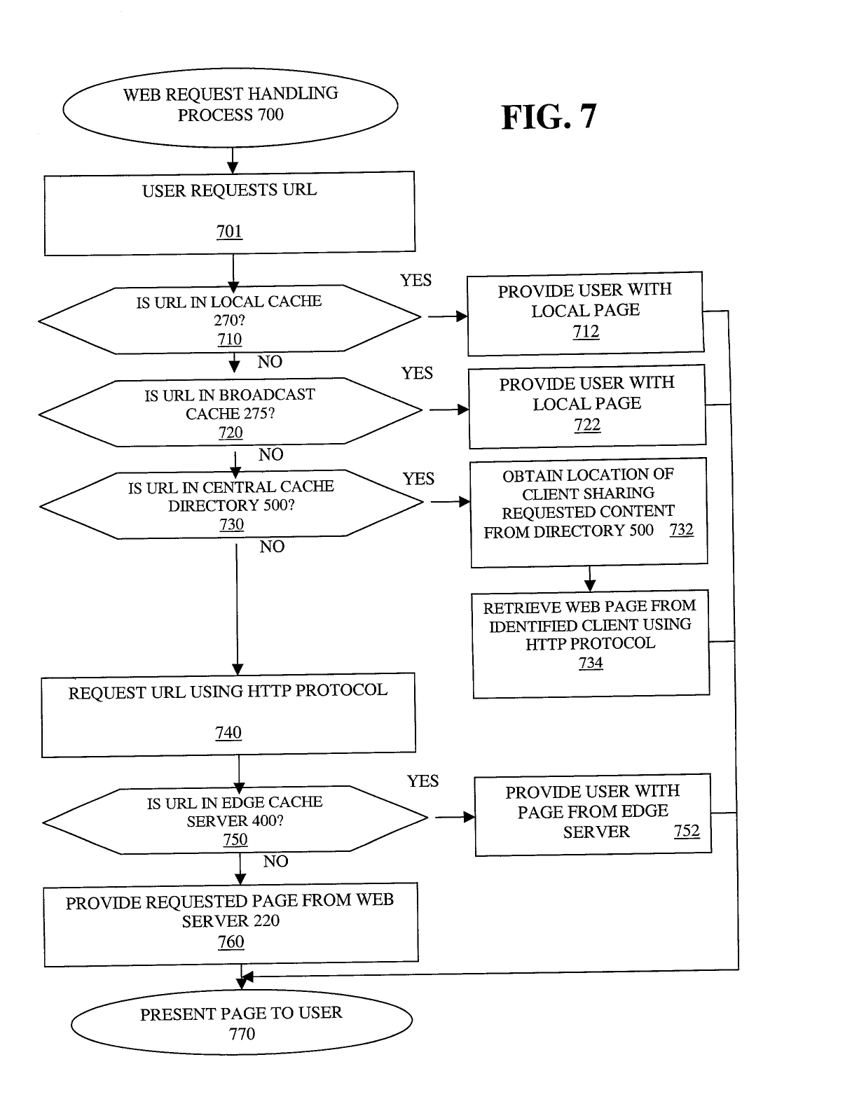

As shown in FIG. 3, and discussed further below in conjunction with FIGS. 6 and 7, the data storage device 320 of each broadcast-enabled client computer 300 contains a cache maintenance process 600 and a web request handling process 700. Generally, the cache maintenance process 600 selects the broadcast material that will be stored in the broadcast cache 275. The web request handling process 700 obtains requested content in accordance with the present invention by determining if it is available in the local cache 270 or broadcast cache 275 before accessing the broadcast cache 275 of another user, the edge server cache 230 or the original web site 220.

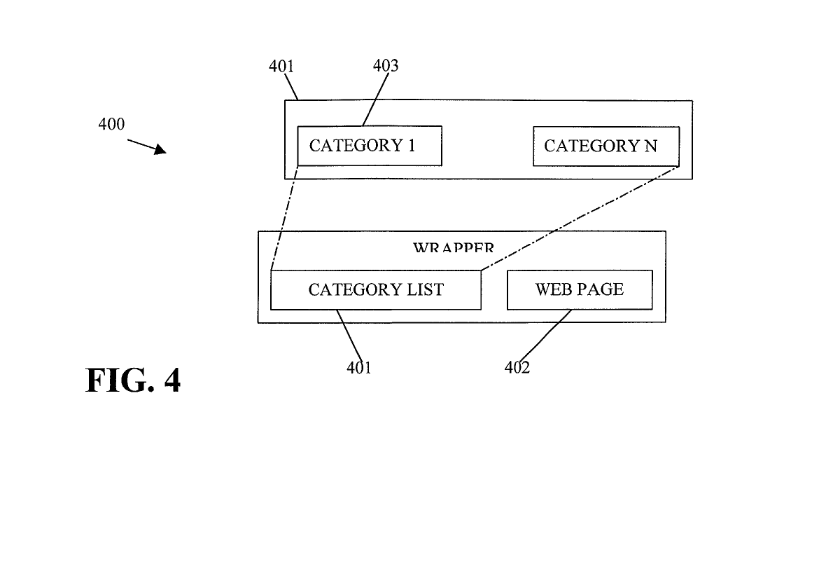

FIG. 4 illustrates an exemplary data structure 400 for the delivery of exemplary category-enhanced web pages. A category-enhanced web page contains additional attributes of the content. These additional attributes correspond to the “Categories” as described in U.S. Pat. No. 6,021,419, incorporated by reference herein. As shown in FIG. 4, a category-enhanced web page is presumed to contain a category list 401 and the original content 402, e.g., the web page, encapsulated by some wrapper. The category list 401 is assumed to be a list of categories 403. One possible embodiment for the syntax of the wrapper is the eXtended Markup Language (XML). This syntax is well understood for the expressive way in which it tags data values. In the exemplary embodiment, the category list 403 and web page 402 will be tagged with XML tags marking them as such and the entire content will be sent as an XML structure.

Those skilled in the art will readily understand this mechanism for the delivery of tagged data between computing devices. The techniques of U.S. Pat. No. 6,021,419, incorporated by reference above, may then be used to control, on the client side 300, the selection of material that is deemed to be of interest to a particular user using, for example, the USER-ADD, USER-DELETE and other commands. In this manner, the client side computer 300 can cache only that material of interest to them in accordance with the category/preference lists that have been set up.

FIG. 5 is a sample table from the central cache directory 500. As indicated above, the central cache directory 500 is a directory of the cached content stored by one or more clients attached to the network 215. It is noted that the central cache directory 500 may be stored by some central server, or any individual client. As shown in FIG. 5, the central cache directory 500 maintains a plurality of records, such as records 501-503, each associated with a different content item, such as a Web page. For each content item identified in field 520, the central cache directory 500 identifies the Internet Protocol (IP) address of the one or more broadcast-enabled clients 300 that have cached the content item in field 530 and a corresponding time-stamp in field 540.

### Broadcast-Enabled Client Processes

FIG. 6 is a flow chart describing an exemplary implementation of the cache maintenance process 600. As previously indicated, the cache maintenance process 600 processes incoming material received from the broadcast channel and selects the broadcast material that will be stored in the broadcast cache 275. As shown in FIG. 6, the cache maintenance process 600 initially receives a category enhanced web page 400 over the broadcast channel 210 during step 601. A test is then performed during step 602 to determine if the category in the category enhanced web page 400 matches the users preference list, as described in U.S. Pat. No. 6,021,419. If the category list provides a match with the user's preference, program control proceeds to step 604, otherwise program control proceeds to step 603.

In step 603 (which assumes that the category list does not provide a match with the users preferences), the category enhanced web page is discarded and the process returns to step 601.

In step 602 (which assumes that the category list does provide a match with the users preferences), a test is performed to see if the broadcast cache 275 has space available for the new web page. If space is available for the new web page, then the process moves to step 605, otherwise program control proceeds to step 610.

In step 610 (which assumes that there is no space in the broadcast cache for the new web page), the least recently used web pages are deleted from the broadcast cache 275 to accommodate the new page. It is noted that to support this, it is necessary that each time a cached web page is used by the client, its recent usage must be recorded (e.g., by maintaining a timestamp associated with it in the broadcast cache 275) as must an efficient way for deleting the least recently used pages. The process then continues to step 605.

In step 605 (which assumes that there is space in the broadcast cache 275 for the new web page), the new category enhanced web page 400 is inserted into the broadcast cache 275 and made available to the user. In a “push” implementation, a notice is optionally sent to the central cache directory 500 during step 606 identifying the new cached content. The process then returns to step 601 waiting for the next page to be delivered.

FIG. 7 is a flow chart describing an exemplary implementation of the web request handling process 700. As previously indicated, the web request handling process 700 obtains requested content in accordance with the present invention by determining if it is available in the local cache 270 or broadcast cache 275 before accessing the broadcast cache 275 of another user, the edge server cache 230 or the original web site 220. As shown in FIG. 7, the web request handling process 700 initially receives a user request from within a browser (or some other Web accessing component) for a URL.

In step 710, a test is made to see if this request can be satisfied from the local cache 270 and if so, the process moves to step 712, otherwise the process moves to step 720. In step 712 (which assumes the URL request can be handled by the local cache 270), the process 700 responds to the users request with the locally stored material. The process has then completed the users request and moves to step 770.

In step 720, (which assumes the material is unavailable from a local cache 270), a request for the material is issued against the broadcast cache 275. If the URL is in the broadcast cache, the process moves to step 722, otherwise program control proceeds to step 730. In step 722 (which assumes the material is available in the broadcast cache 275), the material in the broadcast cache 275 is passed to the user and the process moves to step 770. It is noted that if a given client is not a broadcast-enabled client, i.e., the client does not have access to a broadcast channel, and thus does not maintain its own broadcast channel, then steps 720 and 722 are not performed.

In step 730 (which assumes the material is unavailable in the broadcast cache 275), a request for the material is issued against the central cache directory 500. If the URL is in the central cache directory 500, the process moves to step 732, otherwise program control proceeds to step 740. In step 732 (which assumes the material is identified in the central cache directory 500), the location of the client 300 that is sharing the requested material is obtained from the central cache directory 500. Thereafter, the requested material is obtained from the sharing client 300 during step 734, e.g., using the http protocol, and the process moves to step 770.

If the requested material cannot be obtained from the local cache 270, the broadcast cache 275, or the broadcast cache 275 of another user, then a request is issued to the relevant web host using the http protocol during step 740 and program control proceeds to step 750.

In step 750, the request may be intercepted by a web edge server cache 230 (e.g., an Akamai server) which then checks to see if this request can be served from its cache. This step requires access to the Internet over the point-to-point channel 215. If the material is available in the edge server 230, the process 700 moves to step 752, otherwise program control proceeds to step 760.

In step 752 (which assumes the edge server 230 has the material), the edge server 230 responds to the request with the cached material thus speeding up the response time and reducing inter-network traffic. Program control then proceeds to step 770.

In step 760 (which assumes that the edge server 230 does not have the material available), the request continues to the host site 220 which returns the relevant material.

In step 770, the material can then be viewed by the user. Program control then terminates.

In addition to the many benefits described above, the broadcast edge server can be used to deliver other sorts of information material in addition to Web pages. In particular, one innovation that is derived from the notion of a broadcast edge cache server 250 and associated broadcast cache is the ability to include common materials that might be relevant to many users simultaneously or substantially simultaneously with the differences in materials being sent over the bidirectional link 215. For example, an interactive game might be used by many hundreds of users at the same time. In this event, the broadcast channel 210 can be used to deliver the common content (e.g., background scenes) to all of the users at once, while the user specific information takes place over the point to point link 215. As with the other innovations, the advantage of this approach is the apparent increase in web access speed by using the technique, and the efficient utilization of network bandwidth for content delivery.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principles of this invention and that various modifications may be implemented by those skilled in the art without departing from the scope and spirit of the invention.

What is claimed is:

1. A method for storing digital content in a client-side cache, said method comprising the steps of:
receiving content broadcast from a central server;
storing said received content in said client-side cache; and
making said content in said client-side cache available to other clients.

2. The method of claim 1, further comprising the step of determining if requested content is in said client-side cache before requesting said content from a remote source.

3. The method of claim 1, further comprising the step of requesting said content from an edge server if said requested content is not in said client-side cache.

4. The method of claim 1, further comprising the step of requesting said content from a provider of said content if said requested content is not in said client-side cache.

5. The method of claim 1, further comprising the step of requesting said content from another client cache if said requested content is not in said client-side cache.

6. The method of claim 5, wherein said step of requesting said content from another client cache further comprises the step of accessing a directory to determine where said content is cached.

7. The method of claim 1, further comprising the step of providing information to a central cache directory regarding content that is stored in said client-side cache.

8. The method of claim 1, wherein said content in said client-side cache is made available to other clients using a point-to-point link.

9. A method for obtaining content over a network, said method comprising the steps of:
determining if requested content is in a local cache; and
requesting said content from a remote client cache if said requested content is not in said local cache.

10. The method of claim 9, further comprising the step of requesting said content from a remote source if said requested content is not in said remote client cache.

11. The method of claim 9, further comprising the step of requesting said content from an edge server if said requested content is not in said remote client cache.

12. The method of claim 9, further comprising the step of requesting said content from a provider of said content if said requested content is not in said remote client cache.

13. The method of claim 9, wherein said step of requesting said content from a remote client cache further comprises the step of accessing a directory to determine where said content is cached.

14. The method of claim 9, wherein said remote client cache obtains said content over a broadcast connection.

15. A method for sharing digital content among a plurality of users, said method comprising the steps of:
storing content broadcast from a central server in a client-side cache of at least one client;
making said content in said client-side cache available to a plurality of additional clients; and
maintaining a directory of said content made available to a plurality of additional clients.

16. The method of claim 15, wherein a user determines if requested content is in said directory before requesting said content from another remote source.

17. The method of claim 15, wherein said content in said client-side cache is made available to other clients using a point-to-point link.

18. A system for storing digital content in a client-side cache, said system comprising:
a memory that stores computer-readable code; and
a processor operatively coupled to said memory, said processor configured to implement said computer-readable code, said computer-readable code configured to:
receive content broadcast from a central server;
store said received content in said client-side cache; and
make said content in said client-side cache available to other clients.

19. A system for obtaining content over a network, said system comprising:
a memory that stores computer-readable code; and
a processor operatively coupled to said memory, said processor configured to implement said computer-readable code, said computer-readable code configured to:
determine if requested content is in a local cache; and
request said content from a remote client cache if said requested content is not in said local cache.

20. A system for sharing digital content among a plurality of users, said system comprising:
a memory that stores computer-readable code; and
a processor operatively coupled to said memory, said processor configured to implement said computer-readable code, said computer-readable code configured to:
store content broadcast from a central server in a client-side cache of at least one client;
make said content in said client-side cache available to a plurality of additional clients; and
maintain a directory of said content made available to a plurality of additional clients.

21. An article of manufacture for storing digital content in a client-side cache, comprising:
a computer readable medium having computer readable code means embodied thereon, said computer readable program code means comprising:
a step to receive content broadcast from a central server;
a step to store said received content in said client-side cache; and
a step to make said content in said client-side cache available to other clients.

22. An article of manufacture for obtaining content over a network, comprising:
a computer readable medium having computer readable code means embodied thereon, said computer readable program code means comprising:
a step to determine if requested content is in a local cache; and
a step to request said content from a remote client cache if said requested content is not in said local cache.

23. An article of manufacture for sharing digital content among a plurality of users, comprising:
a computer readable medium having computer readable code means embodied thereon, said computer readable program code means comprising:
a step to store content broadcast from a central server in a client-side cache of at least one client;
a step to make said content in said client-side cache available to a plurality of additional clients; and
a step to maintain a directory of said content made available to a plurality of additional clients.
